(19) United States
(12) Patent Application Publication
(10) Pub. No.: US 2021/0068410 A1
(43) Pub. Date: Mar. 11, 2021

(54) SYSTEM AND METHOD FOR SANITIZING EGGS

(71) Applicant: SIGNIFY NORTH AMERICA CORPORATION, Somerset, NJ (US)

(72) Inventors: ZDENKO GRAJCAR, ORONO, MN (US); STEPHAN AARON, CHANHASSEN, MN (US); DAVID NATARELLI, IONIA, NY (US)

(21) Appl. No.: 16/956,906

(22) PCT Filed: Dec. 21, 2018
(86) PCT No.: PCT/US18/67265

§ 371 Date: Jun. 22, 2020

Related U.S. Application Data
(60) Provisional application No. 62/609,645, filed on Dec. 22, 2017.
(60) Provisional application No. 62/623,079, filed on Jan. 29, 2018.

(51) Int. Cl. A23B 5/015; A23B 5/18; A23B 5/20; A23B 5/14

(52) U.S. Cl. CPC A23B 5/015; A23B 5/14; A23B 5/20; A23B 5/18

(57) ABSTRACT

This disclosure relates to techniques to sanitize eggs. More specifically to sanitizing eggs in a manner such that damage to the cuticle of the egg during sanitization is reduced or eliminated. A method includes the activation of photoactivated sanitizing agent with an appropriate wavelength of light at an intensity that eliminates, reduces, or slows the production of, pathogens on the shell of an egg. The photoactivated sanitizing agent can include an exogenously-applied photoactivated sanitizing agent and an optional photosensitizer, which can be activated with light having a wavelength known to activate the exogenously-applied photoactivated sanitizing agent. The photoactivated sanitizing agent can include an endogenously-derived photoactivatable compound. Light in the Soret band can be utilized to activate the endogenously-derived photoactivated sanitizing agent.

### CLAIM OF PRIORITY

This patent application claims the benefit of priority of Grajcar, U.S. Provisional Patent Application Ser. No. 62/609,645 entitled “SYSTEM AND METHOD FOR SANITIZING EGGS,” filed on Dec. 22, 2017 (Attorney Docket No. 12-183P), and Grajcar, U.S. Provisional Patent Application Ser. No. 62/623,079 entitled “SYSTEM AND METHOD FOR SANITIZING EGGS AND OTHER FOODS,” filed on Jan. 29, 2018 (Attorney Docket No. 12-185P), the benefit of priority of each of which is claimed hereby, and each of which are incorporated by reference herein in its entirety.

### TECHNICAL FIELD

This document pertains generally, but not by way of limitation, to preventing, slowing the growth of, or killing pathogens that may exist on food articles, including eggs.

### BACKGROUND

Egg production, in avian species such as chickens or turkeys, has become a commercial industry. In layer and breeder facilities, hens lay eggs onto an angled floor which rolls the egg toward an edge of the cage (floor angle is generally eight to ten degrees) onto a belt. The belt transports the eggs out of the house either to an egg processing facility or to a storage cooler. Once the eggs enter the egg processing center, they may be washed with a detergent solution near 100° F., pH 11.0, that removes soil, visually inspected (e.g., checked for eggshell problems, cracks, and blood spots), and then graded for packaging. Following packaging, eggs are moved to a cooler room (40-45° F.), where they await shipment to retail outlets. In a commercial setting, eggs may be collected on conveyers which then route the eggs to a processing facility. Eggs can be fertilized, either naturally, or through artificial insemination. For eggs that are used for hatching, the fertilized eggs are collected and delivered to the hatchery where they may be refrigerated until ready for incubation.

For some eggs, just before the egg is laid, a protective layer called the cuticle is added to the outside of the egg. This coating seals the shell pores, prevents bacteria and other pathogens from getting inside the shell, and reduces moisture loss from the egg. At some egg operations, commercial table eggs are washed after collection to make them clean and presentable. This washing may destroy the protective cuticle. In some instances, eggs for hatching are washed or cleaned and in other instances they are not.

A freshly laid egg may have pathogens such as bacteria, fungi, viruses, or pathogenic protozoans on the shell. Alternatively, these pathogens can be deposited onto the egg from the environment in the laying facility, collection system, storage system, or hatchery. These pathogens can cause illness in consumers of eggs. In an incubator, the pathogens can cause an egg not to hatch if they enter the egg (through the cuticle and eggshell pores) in the hatching process, and kill or damage the embryo. Alternatively, they can impede developing chick embryo growth, resulting in smaller hatched chicks, chicks with reduced quality scores, or increase the prevalence of deformities and birth defects. If the chick becomes exposed during the hatching process or during the time period after the chick has hatched but before the chick is separated from the eggshell debris, the chick may become infected, which can subsequently affect mortality rates and growth rates of post-hatch chicks.

It is known that many types of pathogens can exist on eggs shells and within the egg itself. These can include Escherichia coli, Salmonella, including Salmonella enteritidis and Salmonella typhimurium, Bacillus cereus, Campylobacter, Staphylococcus aureus, Aspergillus, and Avian Influenza. These pathogens may be present on the shell of an egg, so even if a consumer properly cooks an egg before eating it, the consumer can still be at risk merely from handling the egg. While there exist methods for washing or sanitizing eggs, there are problems with the known approaches. For example, some known techniques can be detrimental to the health of workers.

### OVERVIEW

The present inventors have recognized, among other things, that there exists a need for methods and apparatus that can safely and economically sterilize an egg shell and, for some applications, the entire egg (both on the shell and inside the shell). The presently disclosed subject matter can help provide a solution to this problem, such as by providing methods and apparatuses to sanitize eggs that do not damage or destroy the cuticle of the egg. In some example embodiments, a sanitizing agent applied to an egg will retain its effectiveness for the entire life of the egg (until use or hatch).

Additionally, the present disclosure relates methods and apparatus for sanitizing the shell of the egg and for destroying pathogens inside the egg. In some examples, exogenously-applied photoactivated, anti-pathogen compounds are utilized. In other examples, the methods and apparatus disclosed herein rely on endogenously-derived photoactivatable compounds. In some examples, embodiments use blue light, or light in the Soret band having a wavelength around 400 nm, to reduce the pathogen count.

In one example, titanium dioxide, TiO₂, is used as a sanitizing agent. TiO₂ is applied to eggs and then exposed to light. Oxidative radicals are generated by photoexcitation of TiO₂ particles. These radicals react with and damage the pathogens that may be present on the egg shell. In another example, modified TiO₂ may be used as the photoactivated sanitizing agent.

In another example, porphyrins may be used as the photoactivated sanitizing agent. A porphyrin is applied to eggs and then exposed to light. Porphyrins such as protoporphyrin IX and protochlorophyllide are oxidizers that are activated by light waves.

In another example, a light source with a specific wavelength output is used to activate the natural (endogenous) photoactive agents that are in the cuticle or shell of eggs. These may include protoporphyrin or bilirubin, alone or in combination, or with a mixture of coproporphyrin, pentacarboxylic porphyrin or uroporphyrin, or a combination thereof. This example can also include the application of additional photoactivated sanitizing agents.

In another example, the photoactive sanitizing agent may be a mixture of various photoactivated sanitizing agents. In another example, a sanitizing agent is applied to the egg immediately after the egg is laid. A light source may be provided in the collection system to activate the photoactive sanitizer. The sanitizing agent may be a powder, in a solution, or in a slurry, colloid, sol, or suspension.

In another example, light sources may be used in the storage system, refrigeration system, transportation system, incubator, or home storage to activate the photoactive sanitizer.

In another example, blue light, with a wavelength from 360 to 430 nanometers (nm), is used to reduce the pathogen count on eggs without the use of an exogenously-applied photoactive sanitizer. In another example, a high intensity blue light is used to kill pathogens, either on the shell of the egg, inside the egg, or both.

In some examples other photosensitizers are used. These photosensitizers can include various tetrapyrrole structures such as porphyrins, chlorins, bacterio-chlorins, and phthalocyanines. Synthetic dyes such as phenothiazinium salts, rose bengal, squaraines, BODIPY dyes, phenalenones, and transition metal compounds can be used as photosensitizers. Alternatively, natural products such as hypericin, hypocrellin, riboflavin, or curcumin can be used. Other photosensitizers such as fullerenes, quantum dots, genetically encoded proteins, two-proton excitation methods can be used.

In some examples potentiators are used in the photoactivation process. As used herein, a potentiator is a molecule that enhances the performance or activity of the photosensitizer. In one example, sodium azide is used. In another example, potassium iodide (KI) is used. Other alkali metal halogen compounds can also be utilized in the photoactivation process.

In another example, reducing or eliminating pathogens on and/or inside eggs is disclosed. Each of these non-limiting examples can stand on its own or can be combined in various permutations or combinations with one or more of the other examples.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts some parts of an egg.

FIG. 2 is a schematic of a system that can be used to apply a sanitizing agent to an egg and an activating light source.

FIG. 3A depicts an incubation or hatching system that includes an activating light source.

FIG. 3B depicts a block diagram of a control system that controls the incubation or hatching system of FIG. 3A.

FIG. 3C depicts a tray from the incubation or hatching system of FIG. 3A.

FIG. 3D depicts a cross section of three trays from the incubation or hatching system of FIG. 3A.

FIG. 4A depicts a system for reducing pathogen count on eggs.

FIG. 4B depicts a cross section of the system for reducing pathogen count on eggs of FIG. 4A.

FIG. 5A depicts an example of a sanitation box that can be used for eggs.

FIG. 5B depicts an example light tray of the sanitation box of FIG. 5A.

FIG. 6 depicts a system for reducing pathogen count on eggs.

### DETAIL DESCRIPTION

This disclosure provides for photoactivated sanitizing agents that are used on foods such as eggs. Preferably the application of the sanitizing agent does not destroy the cuticle of the egg but rather works with it to protect the egg contents. In some embodiments, the application of the photoactivated sanitizing agent does less, if any, damage to the cuticle than other sanitizing techniques. The sanitizing agent is used to eliminate or reduce the pathogen count on the shell of an egg. Pathogen reduction can, depending on the implementation and presence of a sanitizing agent, can be at least a 2-log reduction, and in some examples, as much as a 5-log reduction.

In one example embodiment, Titanium Dioxide (TiO₂), is used as the sanitizing agent and applied to the exterior of an avian egg, such as a chicken egg. The anatase, brookite, or rutile TiO₂ particles can have an average primary particle size of 15 to 100 nm, but can include larger aggregates made up of smaller primary particles. While TiO₂ can be activated by natural sunlight, it is most effective if used with a light source that emits light having a wavelength around 365 nm, for example, in a range of 345 nm to 385 nm. The TiO₂ can be applied to the egg as a powder. Since TiO₂ is not soluble in water, it may be applied as a slurry, colloid, sol, or suspension in water or other liquid. In some examples, care should be taken to not use so much liquid that the cuticle is damaged or removed from the egg. If applied with a liquid, the egg shell may be dried promptly after application. The activating light can be applied when the egg is wet or after it has been dried.

TiO₂ derivatives have different spectral sensitivities that can extend well into the visible range (e.g., 400-700 nm). TiO₂ derivatives include TiO₂ mixed with metal oxides such as cobalt oxide, lanthanum oxide, molybdenum oxide, silver oxide, tungstic oxide, vanadium pentoxide, iron oxide, copper oxide, or mixtures thereof. TiO₂ can be treated with peroxotitanium acid to produce a photoactive sanitizing agent. Other derivatives include TiO₂ doped with nitrogen.

In one example, curcumin is used either alone or mixed with TiO₂ as the photoactive sanitizing agent. The plant turmeric (Curcuma longa) is very well known in India. The root is harvested, cleaned, dried, and powdered to be used as a spice (turmeric gives curry its golden yellow color) and as a medicine. To obtain curcumin, it is extracted from turmeric. When mixed with TiO₂, the photoactivated sanitizing effect is activated with visible light in the range of approximately 400 to 700 nm.

In another example, porphyrins can be used as the sanitizing agent. Porphyrins such as protoporphyrin IX are oxidizers that are activated by light waves. Protoporphyrin IX is a tetrapyrrole containing 4 methyl, 2 propionic and 2 vinyl side chains that is a metabolic precursor for hemes, cytochrome c and chlorophyll. Protoporphyrin IX is produced by oxidation of the methylene bridge of protoporphyrinogen by the enzyme protoporphyrinogen oxidase. Porphyrin IX species such as deuteroporphyrin IX, hematoporphyrin IX, hematoporphyrin derivative, mesoporphyrin IX and protoporphyrin IX are photosensitizers that can be activated by visible light, yielding highly reactive photoexcited species. While protoporphyrin IX is naturally produced by plants and animals, it can be produced in quantities by purifying it from many living organisms including bacteria, fungi, algae, archaeans, as well as synthetically by organic synthesis techniques. While protoporphyrin IX can be activated by natural sunlight, it is most effective if used with a light source that emits light having a wavelength in a range of 390 nm to 420 nm, or from 400 nm to 410 nm. Other porphyrins have other spectral sensitivities, but generally consist of the Soret band of light having a wavelength of 390-450 nm.

In another example, the photoactive sanitizer, or a potentiator, or both, is applied to the eggs immediately after being laid, while the egg is still warm. As the egg cools, the air chamber and liquid in the egg decrease in volume producing negative pressure within the egg. The negative pressure may cause air, dust, pathogens, and anything else on the egg shell to be pulled into the egg. As an aspect of this example, if the photoactive sanitizer is applied to the egg and activated while the egg is still warm, as the egg cools, there will be fewer or no pathogens available to be pulled into the egg.

In one example, the photoactive sanitizing agent is applied to the egg and activated while the egg is on the collection belt. Following this application, the photoactive sanitizing agent will be activated anytime natural or artificially produced light is available. This allows the egg producer to activate the sanitizing agent during egg collection, storage, and refrigeration. If the egg is used by egg consumers, the sanitizing agent be effective whenever the egg is exposed to the effective light. To more fully take advantage of the sterilizing effect, egg cartons can be porous or transparent to light. If used by a hatchery, the incubation or hatching chambers (or both) can be equipped with light sources to activate the sanitizing agent during the incubation and hatching process.

In one example, a mixture of TiO₂ and curcumin is used as the photoactive sanitizing agent. When the eggs are on the collection belt at an egg laying facility, for example, a slurry or mixture of TiO₂ and Curcumin can be applied to the eggs at various locations. By placing lights that produce a light having a wavelength in the range of 400 to 600 nm over the belt, the pathogen count on the eggs will be reduced before they get to the storage or collection facility. It may also be desirable to spray the photoactive sanitizing agent directly onto the belt to sanitize the belt to prevent cross contamination from occurring.

In another example, the photoactive sanitizing agent can be applied to the egg prior to being loaded into a hatching chamber or after the egg is already in the hatching chamber.

In another example, the TiO₂, porphyrin, or another photosensitizer can be applied as a powder. In this example, a binding agent such as polyethylene glycol, polyvinyl pyrrolidone, polyvinyl alcohol, starch, pre-gelatinized starch, liquid glucose, cellulose ethers, waxes, pectic, gums, or the like can be included with the photoactive sanitizing agent to help retain the photoactive sanitizing agent on the egg.

As used herein, the terms photoactive sanitizing agent, photosensitizer, photoactive agent, and photoactive sanitizer include any molecule that produces a chemical change in another molecule in a photochemical process. The inventors have recognized that molecules that produce a reactive oxygen species (ROS) when exposed to light can be activated by light at specific wavelengths. The ROS is used to reduce or eliminate biological material (pathogens), such as bacteria, viruses, viroids, prions, fungi, parasites, or other contaminants, from the egg or other food articles. Sanitize means to adequately treat surfaces by a process that is effective in destroying pathogens of public health significance or to substantially reducing numbers of pathogens, but without adversely affecting the product or its safety for the consumer.

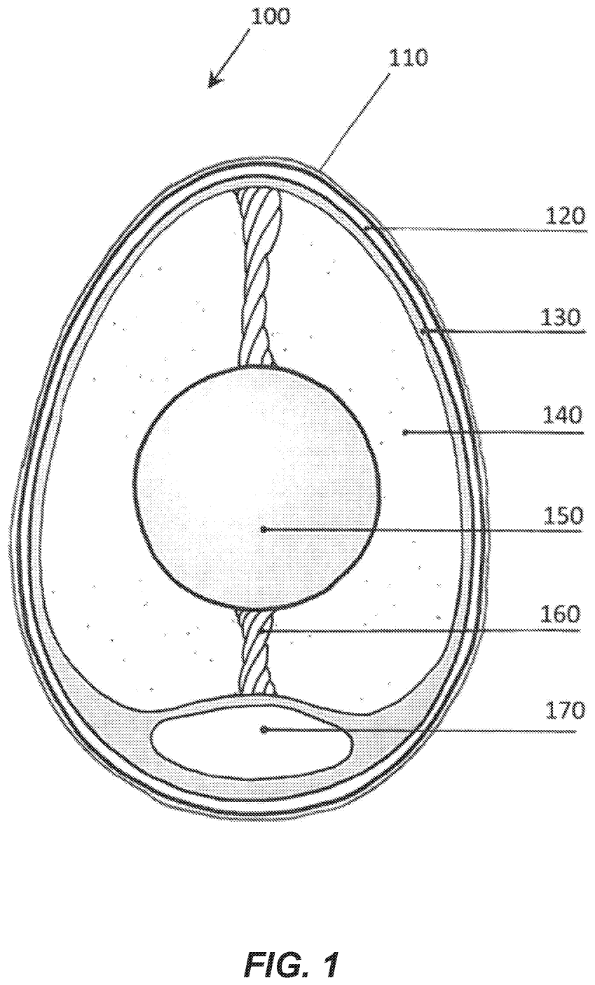

FIG. 1 depicts various parts of an egg 100. The interior of an egg includes, the egg white 140, egg yolk 150, chalaza 160, and air chamber 170. Surrounding these parts are the membrane 130, shell 120, and cuticle 110. The eggshell 120 is made almost entirely of calcium carbonate (CaCO₃) crystals. Air and moisture can pass through the pores of the eggshell 120. The eggshell 120 also has a thin outermost coating called the bloom or cuticle 110 that helps keep out bacteria, other pathogens, and dust. The cuticle 110 is a natural coating or covering on the eggshell that seals the pores of the eggshell 120. The cuticle 110 helps to prevent bacteria and other pathogens from getting inside the egg 100 and reduces moisture loss from the egg 100.

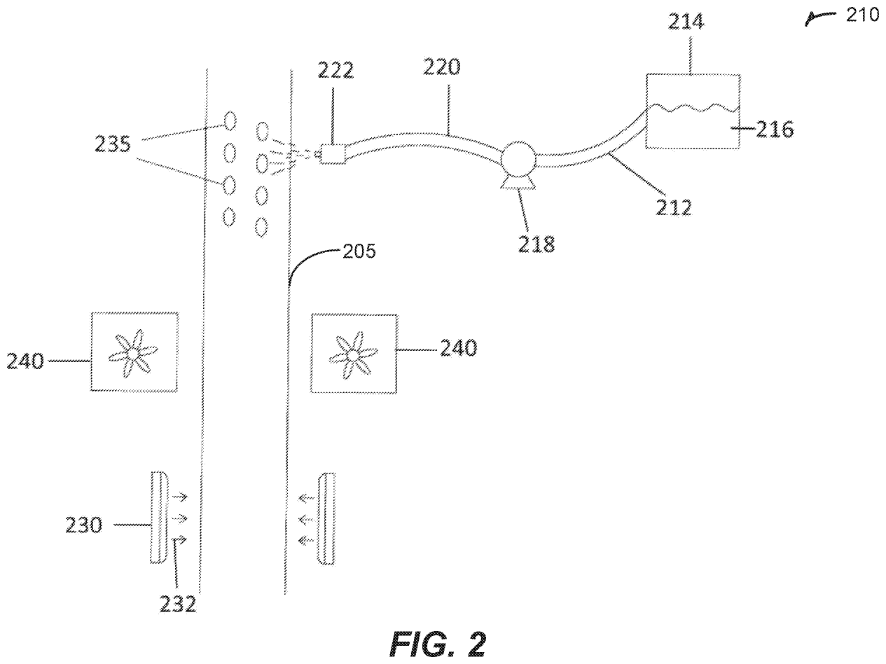

FIG. 2 depicts a system 210 used to apply a photoactive sanitizing agent 216 to eggs 235. The sanitation system 210 includes a first conduit 212 that in an example embodiment is flexible and fluidly attached to a tank or container 214 that holds a volume of photoactive sanitizing agent 216. A pump or other delivery system 218 or other conveying mechanism can be actuated to send pressurized photoactive sanitizing agent 216 through a second conduit 220. Secured to the conduit 220 and receiving the sanitizing agent 216 is a nozzle 222. Nozzle 222 is positioned adjacent eggs 235 such that when delivery system 218 is actuated the photoactive sanitizing agent 216 is misted, sprayed, or delivered onto the shells of the eggs 235.

Also depicted in FIG. 2 is light source 230 that emits light 232 that activates the sanitizing agent 216. If desired, a drying system 240, can be used to dry the eggs. Drying system 240 can be a heater, fan, a combination of a heater and fan, or the like. While light source 230 is shown as being on either side of a belt 205 for conveying the eggs 235, the light source 230 could also be positioned above or below the belt 205. Light source 230 can include a plurality of light emitting diodes (LEDs) that emit light having one or more specific wavelengths suitable to activate the sanitizing agent 216. Reflectors, not depicted, can also be used to help distribute the light to the eggs.

LEDs are a preferred mechanism for delivering a specific wavelength of light, however other light sources can be used to produce the light with the appropriate wavelength(s) needed to activate the photoactive agent including incandescent lamps, compact fluorescent lamps, fluorescent tubes, or discharge lamps. Alternatively, or in combination, a laser or other directional light beam could be used for spot sanitation.

The system 210 allows the eggs to roll or move so that all surfaces of the eggs 235 are coated with the sanitizing agent 216 and exposed to the light. While FIG. 2 depicts a spray system, the photoactive sanitizing agent can be applied in any manner that provides for the agent to be applied to the entire surface of the egg. This can include dipping, painting, air brushing, spraying, and the like. If the sanitizing agent 216 is in a powdered form, the same methods of applying can be used or forces such as electrostatic can be used to keep the powder on the egg. Additionally, the photoactive sanitizing agent 216 can optionally be applied to belt 205 for conveying the eggs 235 such that the light 232 activates the sanitizing agent 216, thereby reducing the pathogen population on belt 205 and reducing the risk of cross-contamination of eggs 235.

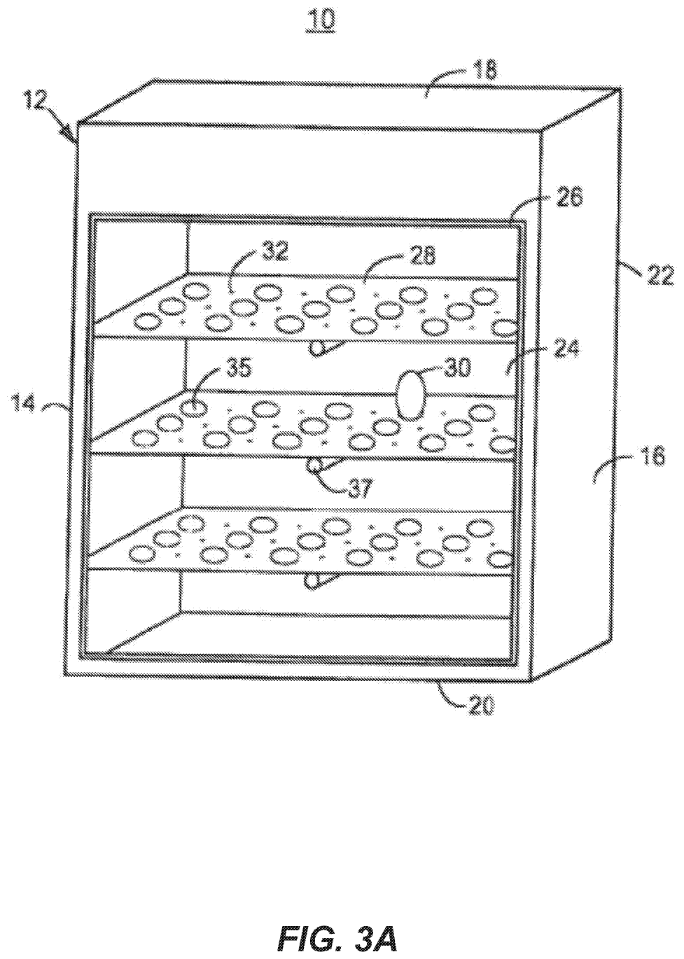

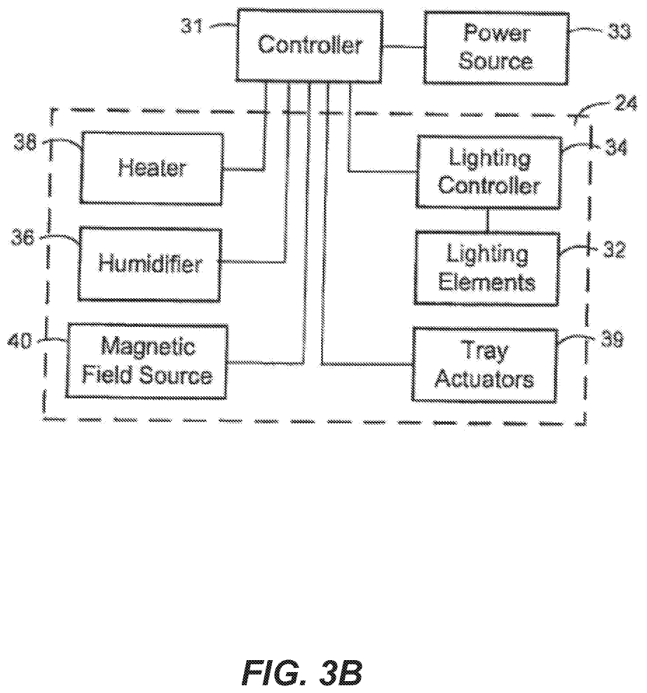

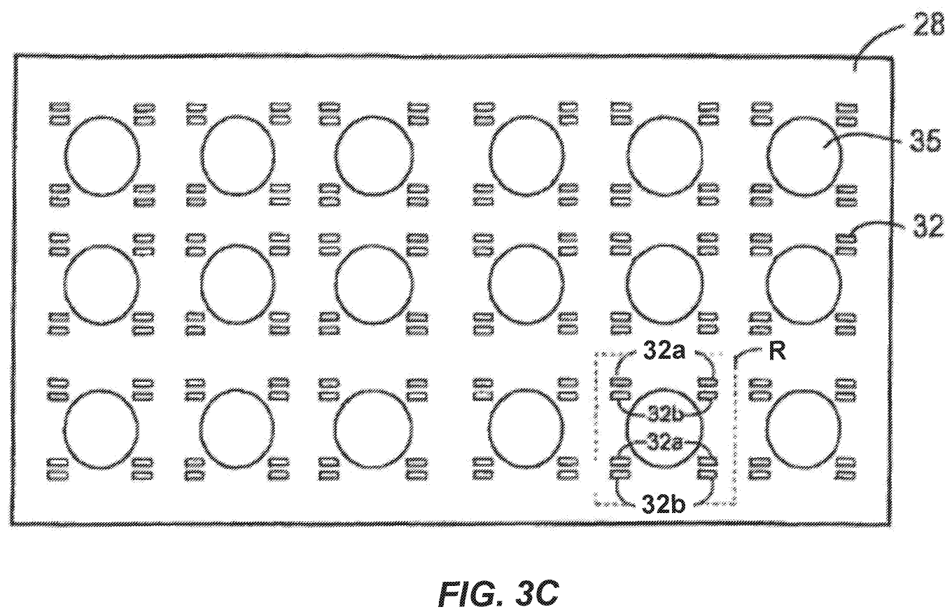

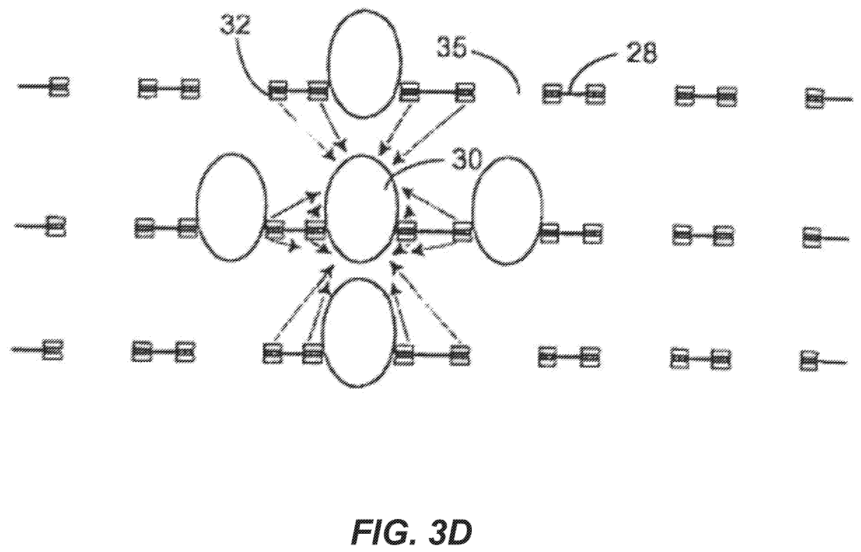

FIG. 3A depicts an incubation or hatching system that includes an activating light source to reduce pathogens within an incubation or hatching chamber. Before placing eggs 30 in incubating device 10, the eggs 30 are treated with a photoactive sanitizing agent. The incubating device 10 includes a body 12. In the illustrative example depicted in FIG. 3A, the body 12 has a generally rectangular cuboid shape having a first sidewall 14 and a second sidewall 16 parallel to each other. The first and second sidewalls 14 and 16 are connected to an orthogonal top wall 18 and a bottom wall 20 that are themselves in parallel to each other. A back wall 22 defines a hollow interior cavity 24 of the body 12. A front wall or door 26 is hingedly connected to one of the sidewalls 14 or 16 to allow access to the interior cavity 24 of the body 12, while also enabling the interior cavity 24 to be isolated from the outside environment when the door 26 is closed. In some examples, the door 26 is made of a transparent material or includes a window to allow a user to view the interior cavity 24 while the door 26 is closed. In other examples, the door 26 completely encloses the interior cavity 24. The door 26 may further be formed of one-way window such that a user can view the interior cavity 24 from outside, while light from outside of the cavity 24 does not enter the cavity 24 through the window. The body 12 generally shields the inside of the incubating device 10 and eggs 30 located in the incubating device 10 from radiation, including light, that is present outside of the incubating device 10.

A plurality of holding members or trays 28 are disposed within the interior cavity 24. The trays 28 are configured to receive and stably hold a plurality of eggs 30. As shown, each tray 28 can include a plurality of slots, holes 35, or other cups each configured to stably hold one egg. The trays 28 are mounted to the interior of the body 12. In some examples, the trays 28 are mounted on one or more actuators that enable the trays 28 to move with respect to the body 12. In one example, each tray 28 is mounted on a rotatable axle 37 mounted to and controlled by a rotational actuator 39 (see FIG. 3B). The actuator 39 is itself mounted to the body 12 and is operative to move the trays 28 with respect to the body 12. The actuator may continuously or periodically move the trays 28 having the eggs 30 disposed thereon. In one example, the actuator 39 is operative to rotate the tray between a horizontal position (as shown) and angled positions in the clockwise and counter-clockwise directions. The angled positions may correspond to angles measured from the horizontal and may range between 0° and a maximum angle (e.g., 150 or 30°). The maximum angle is generally selected such that even when the tray is rotated to the maximum angle, any eggs 30 disposed on the tray 28 are not dislodged from their slots, holes 35, or cups. The trays 28 rotate or tilt to various angles in response to actuators 39 to simulate the movement the egg would encounter in nature, for example as the egg is laid upon by a hen or subject to other environmental conditions.

FIG. 3C provides a detailed top view of a tray 28, while FIG. 3D provides a cross-sectional view through multiple trays 28. Note that in some embodiments, the top and bottom views of a tray 28 are substantially identical, and in such embodiments a bottom view of a tray 28 may thus be substantially identical to the view shown in FIG. 3C.

As shown in FIGS. 3C and 3D, a plurality of lighting elements 32 are disposed on one or both surfaces of each tray 28. In one example, the lighting elements 32 are disposed only on an underside of each tray 28. In another example, the lighting elements 32 are disposed only on an upper surface of each tray 28 (corresponding to a surface on which the eggs 30 are disposed). In other examples, the lighting elements 32 are disposed on both the underside and the upper surface of each tray 28, as shown in FIG. 3D. Lighting elements 32 can additionally or alternatively be disposed on surfaces of the body 12 (e.g., surfaces of the interior cavity 24), or other locations from which light or radiation emitted by the lighting elements 32 reaches the eggs 30.

In general, the lighting elements 32 are disposed such that they can provide light to each egg 30 disposed in the incubating device 10. The lighting elements 32 may thus be disposed in close proximity to the slots, holes 35, or cups holding the eggs 30, as shown in FIGS. 3C and 3D. Further, in some examples, the lighting elements 32 are disposed such that light emitted by the elements 32 can reach all or substantially all surfaces of each egg 30. Hence, as shown in FIG. 3D, an egg 30 can receive light emitted by the elements 32 from all sides. The trays 28 and of the slits, holes 35, or cups for holding the eggs 30 can also be designed so as to enable substantially all surfaces of each egg 30 to receive light. The lighting elements 32 are electrically connected to one another and to an electrical power source 33 (shown in FIG. 3B).

The incubating device 10 can include various systems for controlling conditions within the interior cavity 24 of the device 10. FIG. 3B depicts a block diagram of a control system having a controller 31 operative to control environmental and other conditions within the interior cavity 24. As shown in FIG. 3B, the incubating device 10 can thus include a heater 38 or cooler for controlling a temperature in the interior cavity 24, and a humidifier 36 or de-humidifier for controlling a level of moisture in the interior cavity 24. An optional magnetic field source 40 can further be used to apply a constant or time-varying magnetic field or flux within the interior cavity 24 in response to an excitation current applied to the magnetic field source 40. In embodiments including a magnetic field source 40, the walls of the body 12 and/or the interior walls of the cavity 24 may provide magnetic shielding and provide a return path for the magnetic field or flux applied to the cavity 24. Each of the systems can receive power for operation from power source 33.

The controller 31 controls environmental and other conditions within the interior cavity 24. The controller 31 can activate and de-activate each system and can further regulate the operation of the systems to reach a pre-determined temperature, humidity, magnetic field or flux, or the like. The controller 31 may include or be electrically coupled to sensors (not shown) located in the interior cavity 24 that provide the controller 31 with information on current environmental conditions including temperature, humidity, and the like. In some examples, the controller 31 includes a clock and is operative to control the systems according to a pre-determined schedule. The controller 31 may thus operate the systems on a periodic basis (e.g., by repeating an activation pattern each day), or on another time-varying basis (e.g., by activating the systems according to different patterns on each day of incubation).

A lighting controller 34 is operative to control operation of the lighting elements 32. The lighting controller 34 can be separate from the controller 31 (as shown), or the lighting controller 34 can be integrated within the controller 31. The lighting controller 34 can control the intensity and wavelength of light emitted by each lighting element 32. The lighting controller 34 can further activate or dim the lighting elements 32 on a continuous or on a time-varying basis (e.g., a periodic or an aperiodic basis). The lighting controller 34 can operate different sets of lighting elements 32 individually, for example to cause a first set of lighting elements 32 to be activated for a particular period of time (or at a particular intensity level) and cause a second set of lighting elements 32 to be activated for a different period of time (or at a different intensity level).

In an example, the lighting controller 34 is operative to control a wavelength of light emitted by the lighting elements 32. In particular, the plurality of lighting elements 32 can include multiple sets of lighting elements 32 each operative to produce light having a different wavelength. For example, the plurality of lighting elements 32 can include a first set of lighting elements operative to produce light having a wavelength within a first range of wavelengths (e.g., 410-450 nm, 450-495 nm, or another narrow wavelength range), and a second set of lighting elements operative to produce light having a wavelength within a second range of wavelengths (e.g., 410-450 nm, 450-495 nm, or another narrow wavelength range) different from and non-overlapping with the first range. In some example embodiments, the lighting elements can emit green light in the range of 540 nm to 570 nm. In some example embodiments, the lighting elements can emit red light in the range of 620 nm to 660 nm. The plurality of lighting elements 32 can further include additional sets of lighting elements operative to produce light having other wavelengths. The lighting controller 34 is operative to control each set of lighting elements 23 separately and can thereby adjust the range of wavelengths of light that is emitted by the plurality of lighting elements 23 by selectively activating the different sets of lighting elements 23 at respective lighting intensities.

In general, the eggs disposed inside of the incubating device 10 are shielded from light and other radiation that is present outside of the incubating device 10. As a result of the shielding, including the shielding provided by the incubating device 10, the eggs 30 may therefore be only exposed (or substantially only exposed) to the range of wavelengths of light emitted by the lighting elements 23 in the incubating device 10 that are activated during the incubating period. Optionally, the lighting controller 34 may be operative to ensure that no lighting elements 23 producing light with wavelengths substantially concentrated outside of the specified range are activated during the incubation period, or during the period in which the specified range of wavelengths are applied to the eggs.

For example, in region ‘R’ of tray 28 shown in FIG. 3C, different sets of lighting elements 32 are provided: a first set of lighting elements 32a is operative to emit light within one range of wavelengths, while a second set of light elements 32b is operative to emit light within another range of wavelengths. The lighting controller 34 is operative to separately control the sets of lighting elements 32a and 32b such that each set can be activated at a different time and with a different intensity than other sets of lighting elements. Different sets of lighting elements can similarly be provided on the rest of the tray 28 outside of region ‘R’, including on another surface of tray 28.

In other examples, the plurality of lighting elements 32 includes, on a same tray 28, lighting elements emitting electromagnetic radiation and light in the ultraviolet or blue wavelength range, as well as lighting elements emitting light in the red or green wavelength range.

While the incubating device 10 depicted in FIG. 3A is shown as a closed cavity device, the incubating device 10 can alternatively have an open interior cavity as used in commercial incubation chambers, and commonly referred to as setters or hatchers, without falling outside the scope of this disclosure. In particular in such a setting while the lighting elements can be placed on holding members such as tray elements or basket elements to irradiate eggs therein similar to described in this disclosure, a lighting structure or device containing lighting elements that irradiate eggs from outside the interior of the incubation device can be utilized without falling outside the scope of this disclosure.

The photoactive sanitizing agent can be applied prior to the eggs being placed into the incubation device, after the eggs are placed in the incubation device but before the incubation device is placed in an incubation chamber, or while the eggs are in an incubation device within the incubation chamber. The application of the photoactive sanitizing agent can occur at a layer farm, a breeder farm, or at a hatchery. The application may occur through an application system that is secured to the incubation device or through a detached application system that can spray or apply the photoactive sanitizing agent treatment onto the eggs. Application of the photoactive sanitizing agent to the inside of the incubation device or the trays of the incubation device can be utilized to sanitize these surfaces.

In other example embodiments, blue light, without the use of an exogenous photoactive sanitizing agent, is used to reduce the pathogen count on eggs. The blue light will photoactivate a natural protoporphyrin that exists in the egg shells, for example brown chicken eggs. Similar photoactive agents exist in the eggs of other avian species. The blue light, by itself, will kill pathogens, even for eggs that have a smaller amount of natural protoporphyrin, such as white eggs. For eggs with naturally occurring photoactive agents, such as protoporphyrin, treatment with blue light will activate the photoactive agents to kill pathogens.

Applicants have determined that, to be effective, a sufficient amount of blue light is needed to kill the pathogens in a reasonable amount of time. A radiant dose or radiant exposure is the radiant energy received by a surface per unit area. Light radiometric flux density (colloquially, “intensity”) can be measured in Watts or milliwatts per unit area, or with other similar units. A Joule is defined as one Watt of power for one second. If the intensity of light is known or can be measured (units are energy/area/second or, for example, Watts/cm²), the amount of energy delivered to an egg can be calculated by using wattage supplied to the cross-sectional area of the egg exposed to the light multiplied the time of exposure.

To reduce the pathogen load on an egg shell where the shell contains naturally occurring porphyrin, Applicants have determined that a radiant dose of 30 Joules per square centimeter (J/cm²) is needed to kill a reasonable number of pathogens. Radiant doses between three (3) and 300 J/cm² have also been found to be effective. Radiant doses between 15 and 100 J/cm² have also been found to be effective. Radiant doses as high at 300 J/cm² or 500 J/cm² or higher can be used but will result in higher energy consumption. These examples can also be described as delivering sufficient light to the egg to sanitize the egg by causing a reduction in the pathogen count on the egg shell to an acceptable level. An acceptable level can include, for example, at least a 2-log reduction in a pathogen population.

For eggs that contain small amounts of porphyrins (such as white eggs), a dose of 100 J/cm² is needed to reduce the pathogen count. Radiant doses between 50 and 200 J/cm² have also been found to be effective. Radiant doses between 5 and 300 J/cm² have also been found to be effective. Radiant doses as high or higher than 500 J/cm² or 800 J/cm² or higher may be used. These example embodiments can also be described as delivering sufficient light to the egg to reduce the pathogen count to an acceptable level. An acceptable level can include, for example, at least a 2-log reduction in a pathogen population.

The techniques described herein can be used at various points in the egg production, delivery, and storage processes. At commercial egg producing facilities, chickens (or other avian species) may lay eggs in structures that allow the egg to gently roll onto a collection belt. This invention may be used immediately after egg laying while the eggs are still on the collection belt. In an organic egg production facility, such as a small family farm, a radiant dose of blue light at a level between 30 J/cm² and 300 J/cm² can be utilized to safely reduce a pathogen population on fresh or stored eggs.

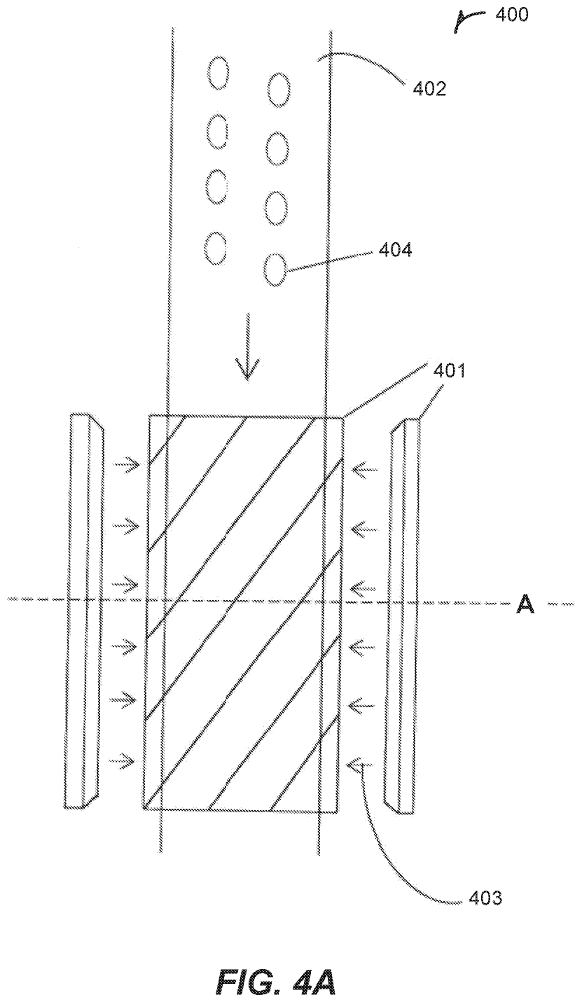

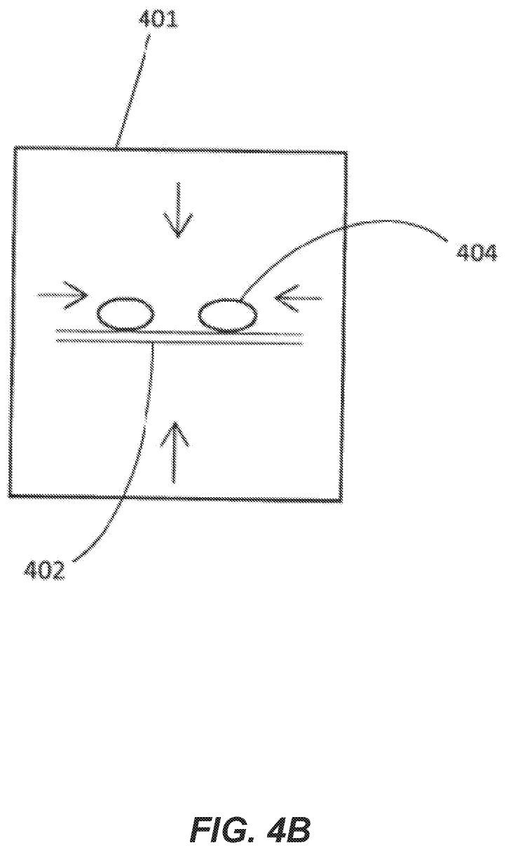

FIG. 4A shows an example of a sanitizing system 400 that can be utilized at an egg production facility. FIG. 4B is a cross section of FIG. 4A at dashed line ‘A’. A hood or covering 401, is constructed around the belt 402. Activating light 403 is applied to the eggs 404 as they travel on the belt 402. Based on the speed of the belt 402 and the length of the run, the radiant dose required (light intensity) can be calculated so that sufficient energy is delivered to sterilize the eggs 404 as they travel under covering 401. As shown in FIG. 4B, light is supplied to the belt and eggs 404 from all directions so that all surfaces of each egg are exposed to the activating light 403. The belt 402, can be constructed of a porous weave or from bars or rods that the eggs 404 sit between, so the bottom of the eggs 404 will be exposed to the light 403 that is emitted from light sources below the belt. Coverings or flaps may also be used with the light hood or covering 401 shown in FIG. 4B so that workers are not exposed to the light 403. It may be beneficial to sterilize the belt 402 either before eggs 404 roll onto the belt 402 so that cross contamination is minimized. The eggs 404 can be exposed to the blue light at any stage in the production, collection and delivery process in order to reduce or limit the growth of pathogens on the eggs, and to reduce or eliminate the risk of new pathogens from cross-contamination.

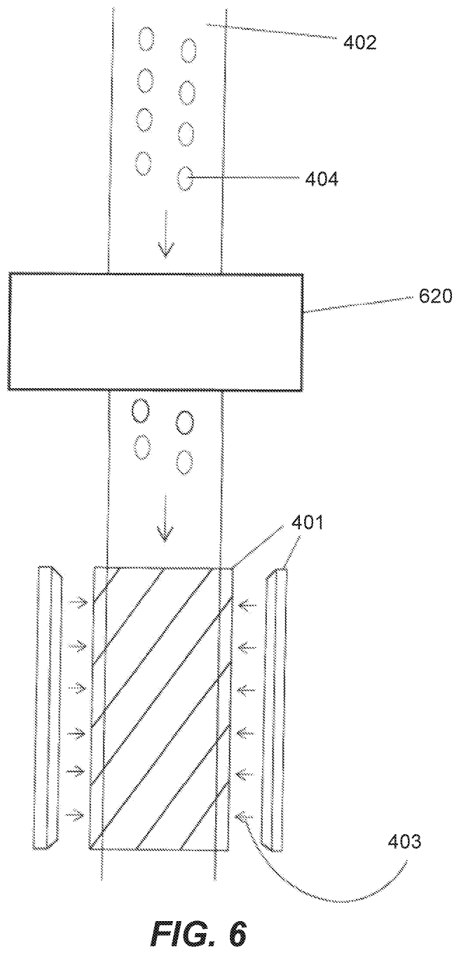

In another example, the system 400 of FIG. 4A can include a pretreatment section 620, shown in FIG. 6. In embodiments where the eggs 404 are treated on the collection belt 402, the pretreatment step may be applied to the eggs 404 and pathogens prior to the light treatment. In an effort to make the light-based treatment of the eggs more effective, Applicants have found that a pretreating step can be beneficial in reducing pathogens on eggs. These pretreatments can include treating the eggs with a sanitizing agent such as bleach, chlorine, or hydrogen peroxide, using heat, using steam, or using ultraviolet C (UVC) light. These pretreatments may be used alone or in combination with another. The pretreatment step does not entirely sanitize the eggs, but rather makes the pathogens more susceptible to the light-based treatment. In the event that a particular pathogen is resistant to the photoactive agent treatment, the pretreatment may be used to kill or reduce the number of these resistant pathogens.

In one example, the egg collection belt moves at a speed of 25 ft/min. If the hood or covering 401 is 50 feet in length, the delivery of a radiant dosage of light and the resulting pathogen reduction will occur during the two-minute period where the egg is under the hood or covering 401. For example, a radiant dose between approximately 30 J/cm² and 200 J/cm² can be applied to the eggs 404 during this two-minute period.

After the eggs are collected at the egg producing facility, the application of the wavelength of light appropriate to activate a photoactive agent can be used where the eggs are stored. For table eggs that are loaded into cartons of, for example, 6, 12, 18 or 24 eggs, the techniques described herein can be used to sanitize both the eggs before they are loaded into the cartons as well as the interior of the cartons themselves if they carry a risk of pathogens. In an example, these techniques can be used at distribution centers, grocery stores, or both, to provide sterilization of eggs.

After eggs have been purchased by a consumer, the techniques described herein can be used in the consumer's home. A sterilization box for home use can be used in the consumer's refrigerator or outside of any refrigeration, for example in a local organic production egg farm.

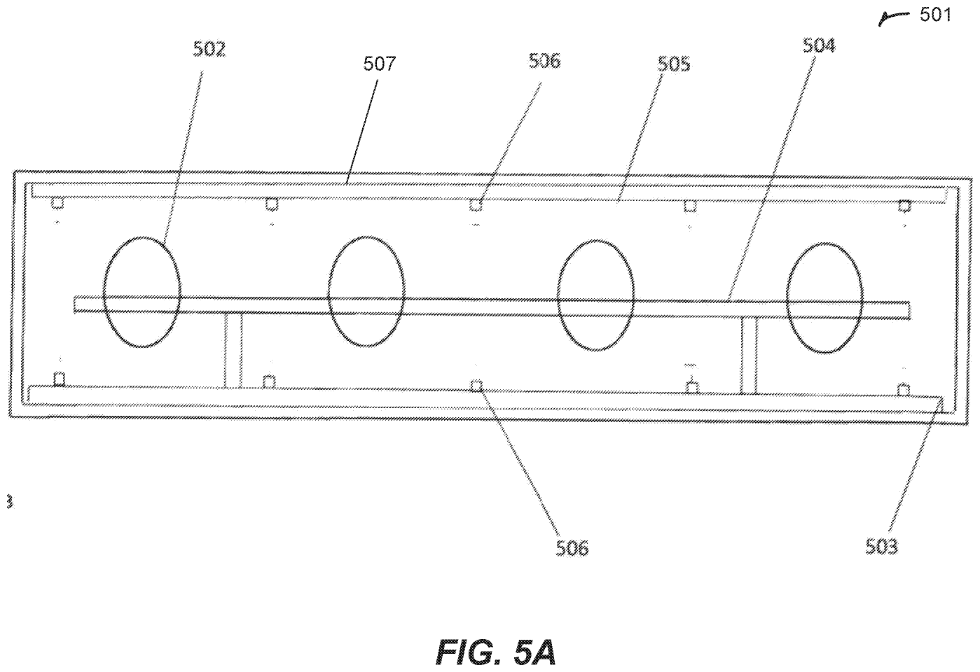

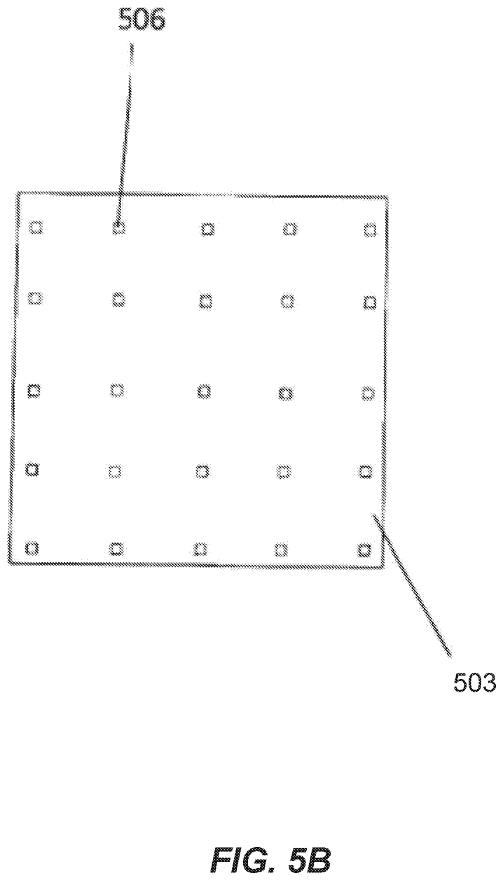

FIG. 5A depicts an example of a sterilization box 501. The sterilization box 501 can be a container constructed from an opaque material that includes a lower light tray 503 positioned below the egg tray 504, and an upper light tray 507 positioned above the egg tray 504. FIG. 5B depicts a top view of an example of the light tray 503. The light tray 503 includes a plurality of light sources 506. The box 501 can be constructed of plastic or other suitable material. The box 501 can have a lower light tray 503, that sits below the egg tray 504. The box can have an upper light tray 507 positioned above the eggs 502, and the egg tray 504. Light sources 506, can be positioned on the light trays 503, 507 so that each egg 502 is exposed to light on all sides. The box 501 can include one or more reflectors, not depicted, attached to interior surface(s) of the box 501 to help distribute the light to the entire surface of each egg 502 in the tray 504. In an example, the egg tray 504 is made of a transparent material.

The egg tray 504 is removable so that the user can readily access the eggs 502. The box 501 can, for example, include a hinged lid to allow the removal of the eggs 502 from the box 501. Alternatively, the box 501 can, for example, include a portal that allows for the removal of the egg tray 504 and eggs 502. While light sources 506, can be any type of light source, light emitting diodes (LEDs) are utilized in a preferred embodiment to reduce energy use. Although not shown, light sources can be utilized on the sides of the box 501 facing the eggs 502. A power supply, not shown, is utilized to power the lights and an electronic control system.

The electronic control system included with the box 501 can be programmed to turn on every time the egg tray 504 is inserted into the box 501. In one example, it may be desirable to sterilize the eggs over a period of 2, 4, 6, 8, or more hours, and at a radiant dosage inversely proportional to the period. The sterilization time could be shorter than 4 hours. In another example, the box may have a ‘sterilize’ setting that allows for an initial sterilization of the eggs at a higher radiant dosage for a shorter period of time. As the eggs remain in the box, a daily or more frequent, perhaps shorter, cycle could be used to ensure that the eggs do not become contaminated or to ensure that the pathogen count stays stable (does not appreciably increase).

The box 501 can be used in the refrigerator or as a counter top unit. For eggs that contain sufficient naturally occurring protoporphyrin, such as brown chicken eggs, an amount of light energy of 5 J/cm² is desirable to reduce the pathogen count to an acceptable level, but an amount of 2 J/cm² to 10 J/cm² may be used. Higher levels, for example 15 J/cm², 100 J/cm², or up to 200 J/mc² can be used effectively to reduce the pathogen count. For white eggs, or for eggs that contain a smaller amount of naturally occurring protoporphyrin, an amount of light energy of 50 J/cm² is desirable to reduce the pathogen count to an acceptable level, but an amount of 30 J/cm² to 100 J/cm² or up to 500 J/cm² can also be used.

In another example embodiment, sterilization box 501 can be a static chamber sized to house multiple-dozens of eggs and include an apparatus to apply a photoactive sanitizing agent to the eggs. For example, the apparatus can include a pump, conduit and nozzle as described above with respect to FIG. 2. In another example embodiment, eggs can be manually treated with the photoactive sanitizing agent (e.g., with a hand pump sprayer or other mechanism) prior to or after being disposed in the box 501.

In some example embodiments other photosensitizers are used. These photosensitizers can include various tetrapyrrole structures such as porphyrins, chlorins, bacterio-chlorins, or phthalocyanines. Synthetic dyes such as phenothiazinium salts, rose bengal, squaraines, BODIPY dyes, phenalenones, or transition metal compounds can be used. Natural products such as hypericin, hypocrellin, riboflavin, or curcumin can also be used. Other photosensitizers such as fullerenes, quantum dots, or genetically encoded proteins can be used. Two-proton excitation methods can be used to provide the appropriate activation wavelength for specific photosensitizers. Many of these potential photosensitizers are activated by light that is not in the blue spectrum. For example, many photosensitizers have peak absorption in the red wavelengths. Some of the photosensitizers have multiple absorption peaks. In these cases, one can utilize the wavelength of any of the peaks to make the reactive oxygen species (ROS) but the optimal wavelength can be chosen based on other factors such as light penetration. Light with longer wavelengths will penetrate the surface to a greater depth than will light of a shorter wavelength.

In some examples, two-photon excitation is used. In this example, two separate photons arrive at the photosensitizer molecule at or about at the same time and, if they are absorbed at the same time, will be an equivalent to a single photon of half the wavelength. This example can be used where longer wavelengths of light are used as they penetrate more deeply into tissue than shorter wavelength light, but the photosensitizer has a peak absorption at a shorter wavelength.

In examples where encoded proteins are used, the ROS can be tagged to a protein that is expressed in the egg shell or cuticle. In this instance, the ROS would then be available for the light treatment of the egg.

Many of the photosensitizers discussed herein can be activated by different wavelengths of light but they will have a single or small range of wavelengths that are most effective. Unless otherwise noted, the wavelengths discussed herein are this most-effective wavelength.

Applicants have also determined that blue light can be used to reduce the pathogen load of the entire egg, not just the shell. It is known that a percentage of light can pass through an egg shell. To reduce the pathogen load within an egg, the applicants have discovered that a radiant dose of 500-5,000 J/cm² is needed, depending on the color of the eggshell. White eggs can be sanitized with a dosage of approximately 500 J/cm², whereas brown eggs can be sanitized with a dosage of approximately 5,000 J/cm².

The pathogen reduction by blue light can be used for table eggs, that is eggs that are consumed. This can include shell eggs or egg products. The use of a photoactivated sanitizing agent would be used for eggs that will be hatched. This is not meant to be limiting and all aspects and examples described herein can be used with either kind of egg.

For some applications where a high light intensity is desired, the light source may increase the local ambient temperature. Additionally, while some of the light will be absorbed by the photoactive agents, some amount of the light energy absorbed and released as heat. There will also be radiant heat emitted by the luminaire. These multiple sources of heat could result in heating the egg. Some temperature elevation will be beneficial in killing the pathogens, but, if too much heat is produced, one would need to counteract the heating with a cooling mechanism. For example, a heat sink would be used with the light source to draw heat away. Alternatively, a cooling system could be provided such that cool air or circulating cooling fluid could reduce the temperature of the local, ambient, atmosphere.

While the techniques discussed herein have been described for use with avian eggs such as chicken, duck, turkey, goose, pheasant, quail, and the like.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for sanitizing eggs comprising:
applying a photoactive sanitizing agent to the shell of an egg; and
illuminating the egg with a radiant dose of a light having a wavelength that activates the photoactive sanitizing agent;
wherein the radiant dose of the light illuminating the egg is sufficient to reduce a pathogen population on the egg;
wherein the wavelength of the light is in the range of 345 nanometers (nm) to 385 nm or 390 nm to 420 nm.

2. The method of claim 1, wherein the sanitizing agent is titanium dioxide or a derivative of titanium dioxide.

3. (canceled)

4. (canceled)

5. The method of claim 1, wherein the sanitizing agent is protoporphyrin IX or a derivative of protoporphyrin IX.

6.-10. (canceled)

11. The method of claim 1, wherein the sanitizing agent is selected from the group of porphyrins, chlorins, bacterio-chlorins, and phthalocyanines, synthetic dyes, phenothiazinium salts, rose bengal, squaraines, BODIPY dyes, phenalenones, transition metal compounds hypericin, hypocrellin, riboflavin, curcumin, fullerenes, quantum dots, and genetically encoded proteins.

12. The method of claim 1, wherein applying a photoactive sanitizing agent to the shell of an egg includes applying a potentiator to the shell of the egg.

13. The method of claim 1, wherein the potentiator is selected from a group comprising: sodium azide, potassium iodide, and an alkali metal halogen compound.

14. The method of claim 1, wherein the radiant dose is at least 30 Joules per square centimeter (J/cm2).

15. The method of claim 1, wherein the radiant dose is in a range between 2 and 500 J/cm2.

16.-28. (canceled)

29. A method of sanitizing eggs, comprising:
providing an egg that contains an endogenous photoactivated sanitizing agent; and
applying a light of a certain wavelength to activate the sanitizing agent and at an intensity that reduces a pathogen population on the egg;
wherein the wavelength of the light is in the range of 390 nm to 420 nm.

30. The method of claim 29, wherein the eggs are on a collection belt in an egg laying facility during the providing and applying steps.

31. The method of claim 30, further comprising: pretreating the eggs prior to applying the light.

32. The method of claim 31, wherein the pretreatment is a treatment with steam, heat, a sanitizing agent, chlorine, bleach, hydrogen peroxide, or ultraviolet C (UVC) light.

33. The method of claim 29, wherein the intensity is at least 30 Joules per square centimeter (J/cm2).

34. The method of claim 29, wherein the intensity is in a range between 2 and 500 J/cm2.

35.-45. (canceled)
